(19) United States
(12) Patent Application Publication
(10) Pub. No.: US 2002/0131157 A1
(43) Pub. Date: Sep. 19, 2002

(54) All-optical wavelength converter and converting method therefor

(76) Inventors: Jung Jin Ju, Taejon (KR); Yoo Hong Min, Taejon (KR); Jung Yun Do, Taejon (KR); Seung Koo Park, Taejon (KR); Myung-Hyun Lee, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 10/003,290

(22) Filed: Dec. 6, 2001

(30) Foreign Application Priority Data
Mar. 15, 2001 (KR) 2001-13302

(51) Int. Cl. G02F 1/365; G02F 1/39

(52) U.S. Cl. 359/332; 359/330; 385/122

(57) ABSTRACT

A wavelength converter for converting wavelength of a signal beam combined to a pump beam. The wavelength converter comprises a mode converting region for converting mode of the pump beam; a direction combining region for combining the signal beam to the pump beam; and wavelength converting region for converting the wavelength of the signal beam combined to the pump beam. The mode converting region and the wavelength converting region are formed as integrated by nonlinear polymeric material to construct a polymeric waveguide extended along propagation direction. The wavelength converting region includes the nonlinear polymer poled to a predetermined direction. According to the present invention, a DFG device, a cascade wavelength converting device, and second harmonic generation device of higher energy converting efficiency can be developed.

### FIELD OF THE INVENTION

The present invention relates to an all-optical wavelength converter for converting a wavelength of a beam signal to another wavelength and a converting method therefor; and, more particularly, to an all-optical wavelength converter using effective refractive index changes of TE and TM propagation modes of an incident beam signal, resulted from poling of polymeric waveguide and a converting method therefore.

### PRIOR ART OF THE INVENTION

Various devices for an optical wavelength converter of waveguide structure using second order nonlinearity have been developed, depending on nonlinear material, a phase matching method, a waveguide manufacturing method.

As a conventional nonlinear material, single crystal oxide such as LiNbO₃, and LiTaO₃, semiconductor such as AlGaAs, InGaAsP and InGaP, and nonlinear polymer material are mainly used. QPM (Quasi Phase Matching) is used as a main phase matching method for the single crystal oxide and semiconductor and MDPM (Modal Dispersion Phase Matching) is used as a main phase matching method for the nonlinear polymer.

On the other hand, as a wavelength converting method, a DFG (Difference Frequency Generation) method and a cascade method where sum frequency generation and difference frequency generation is cascaded are used.

In case of the single crystal oxide, after producing the single crystal to have regular domain inversion structure so as to satisfy QPM condition in order to use a large nonlinear coefficient of d₃₃(˜35 pm/V), a device for wavelength conversion between WDM (wavelength Division Multiplexing) optical communication channels is manufactured by using the DFG and cascade methods. This technique is described in “1.5-m-band wavelength conversion based on cascaded second order nonlinearity in LiNbO₃ waveguide,” M. Chou et al., IEEE Photonics Technology Letters, June 1999, pp. 653-655 and “1.5-m-band wavelength conversion based on difference-frequency generation in LiNbO₃ waveguides with integrated coupling structures,” M. Chou et al., Optics Letters, June 1998, pp. 1004-1006.

In case of the semiconductor, after producing the single crystal to satisfy the QPM condition by way of a series of processes such as wafer bonding by wafer fusion, selective etching and MOCVD (Metal Organic Chemical Vapor Deposition) in order to use a large nonlinear coefficient of AlGaAs d₃₆(˜180 pm/V), a wavelength converting device is manufactured by the DFG method. This technique is described in “Wavelength conversion by difference frequency generation in AlGaAs waveguide with periodic domain inversion achieved by wafer bonding,” S. J. B. Yoo et al., Applied Physics Letters, May 1996, pp. 2609-2611, which exhibits stable operation characteristic but has a drawback of low conversion efficiency due to high pump beam loss of 45 dB/cm at wafer bonding surface.

Further, the nonlinear polymer wavelength converting device has been studied as a device for SHG (Second Harmonic Generation) but there has been not yet developed any WDM wavelength conversion device of the DFG and cascade processes. The fact that the SHG device using the nonlinear polymer has low conversion efficiency in the QPM, that is, lower than specified conversion efficiency 0.5%/W cm², is disclosed in “Vertically stacked coupler and serially grafted waveguide : Hybrid waveguide structures formed using an electro-optic polymer,” T. Watanabe et al., Journal of Applied Physics, January 1998, pp. 639-649. The specified conversion efficiency in the MDPM, 14%/W cm², is disclosed in “Modal dispersion phase matching over 7 mm length in overdamped polymeric channel waveguide,” M. Jager et al., Applied Physics letters, December 1996, pp. 4139-4141.

There have been developed various types of nonlinear polymer devices having large nonlinear coefficient (d₃₃ ˜equal to or greater than 30 pm/V) for the nonlinear polymeric devices having prescribed characteristics. However, these devices have been not yet put to practical use as the all-optical wavelength converting device for the WDM optical communication due to their lack of an effective phase matching method.

On the other hand, refractive index change of the nonlinear polymer, resulting from electrical poling and mechanical stretching related to a birefringence phase matching method of the present invention is disclosed in “Origin of the poling-induced optical loss in a nonlinear polymeric waveguide,” C. C. Teng et al., Applied Physics Letters, February 1995, pp. 667-669, and “Phase-matched second-harmonic generation in poled polymers by the user of birefringence,” X. T. Tao et al., Journal of Optics Society of America B, September 1995, pp. 1581-1585. However, this has been never used for phase matching of a waveguide type wavelength converting device.

### SUMMARY OF THE INVENTION

Therefore, it is an object of the present invention to provide an all-optical wavelength converter for implementing a difference frequency generation wavelength converting device, a cascade wavelength converting device, and a second harmonic wave generation wavelength converting device, which has higher energy conversion efficiency, based on a birefringence phase matching method where difference frequency generation, cascade process, and second harmonic generation occur efficiently.

In accordance with an aspect of the present invention, there is provided a method for converting wavelength of a signal beam combined to a pump beam, which comprises the steps of: providing a channel type polymeric waveguide including nonlinear polymer in the middle of the waveguide; poling the polymer along a predetermined direction by applying a voltage to the polymeric wavegiude; and making the signal beam combined to the pump beam pass through the polymer waveguide in which the polymer is in poled state.

Preferably, in accordance with another aspect of the present invention, there is provided a wavelength converter for converting wavelength of a signal beam combined to a pump beam, which comprises a mode converting region for converting mode of the pump beam; a direction combining region for combining the signal beam to the pump beam; and a wavelength converting region for converting the wavelength of the signal beam combined to the pump beam, wherein the mode converting region and the wavelength converting region are formed as integrated by nonlinear polymeric material to construct a polymeric waveguide extended along propagation direction, and the wavelength converting region is manufactured by including voltage applier for applying a voltage to pole the polymer to a predetermined direction.

Furthermore, in accordance with still another aspect of the present invention, there is provided a method for manufacturing a wavelength converter for converting wavelength of a signal beam combined to a pump beam, by using nonlinear polymeric material, which comprises the steps of: shaping the nonlinear polymeric material to be long; by using the shaped long nonlinear polymeric material as a core, wrapping the core with a cladding with leaving both ends exposed; and forming metal electrodes connected to the core of the nonlinear polymeric material.

### BRIEF DESCRIPTION OF THE DRAWINGS

The above and other objects and features of the instant invention will become apparent from the following description of one embodiment taken in conjunction with the accompanying drawings, in which:

FIGS. 1A and 1B show an all-optical wavelength converter in accordance with one embodiment of the present invention;

FIG. 2 presents a graph for effective refractive index versus poling field of nonlinear polymer and birefringence phase matching condition for DFG wavelength conversion;

FIGS. 3A and 3B illustrate polarization states of an incident beam and an output beam and polarization direction of nonlinear polymer for satisfying BPM of DFG and cascade processes with nonlinear polymer used in the present invention;

FIG. 4 offers a graph for conversion efficiency of an output beam versus waveguide propagation distance in birefringence phase matched DFG;

FIG. 5 is a graph for conversion efficiency of an output beam versus input power of an pump beam in birefringence phase matched DFG;

FIG. 6 shows a DFG wavelength converter of waveguide structure using nonlinear polymer in accordance with the present invention; and

FIG. 7 provides a cascade wavelength converter of waveguide structure using nonlinear polymer in accordance with the present invention.

### PREFERRED EMBODIMENT OF THE INVENTION

Hereinafter, it will be described in detail for an all-optical wavelength converter and a converting method therefor in accordance with one embodiment of the present invention in conjunction with accompanying drawings.

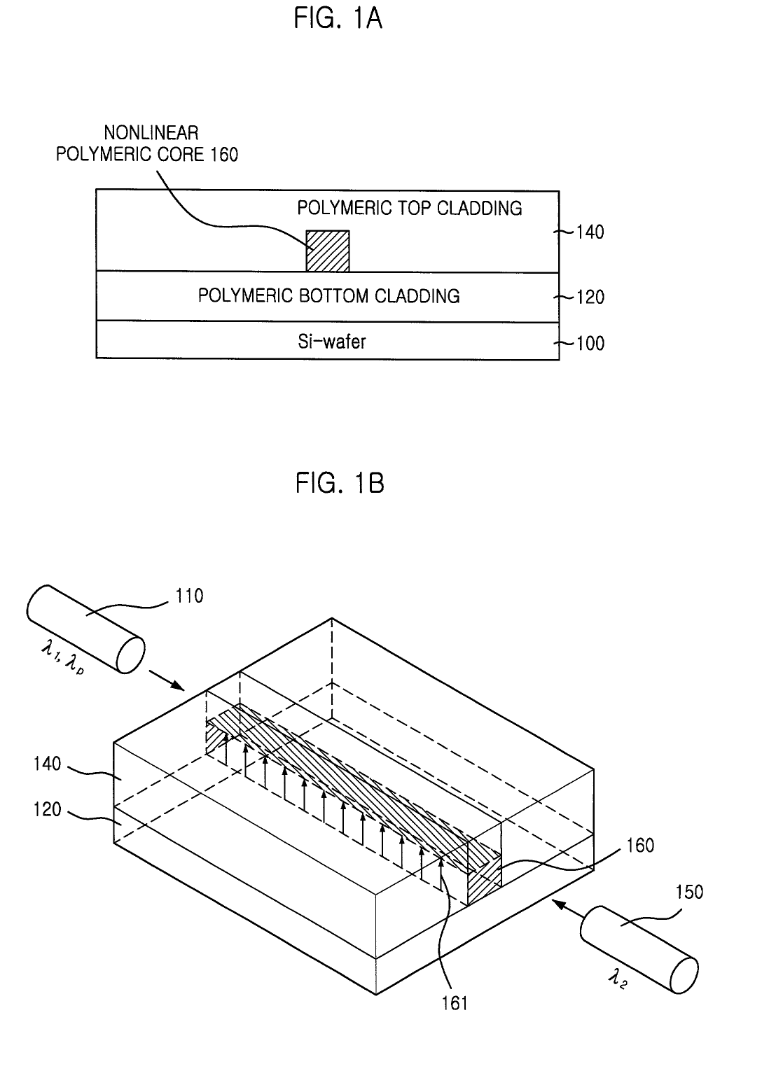

FIG. 1A is a diagram of an all-optical wavelength converter in accordance with one embodiment of the present invention and FIG. 1B shows a cross-sectional diagram of the all-optical wavelength converter as shown in FIG. 1A, which is cut in a direction 1. As shown, the all-optical wavelength converter comprises a polymeric bottom cladding 120 that is formed on a surface of a silicon wafer 100, a nonlinear polymeric core 160 that is formed to extend from an input end to an output end on the polymeric bottom cladding 120, and a polymeric top cladding 140 that covers the nonlinear polymeric core 160 on the polymeric bottom cladding 120 but leaves parts of the input end and the output end exposed. At this time, the nonlinear polymeric core 160 is poled in a direction perpendicular to a wave propagation direction.

Now, it will be described for manufacturing procedure for the all-optical wavelength converter having prescribed configuration.

At first, the polymeric bottom cladding 120 and the nonlinear polymeric core 160 are formed subsequently on the surface of the silicon wafer 100 by using spin coating. Then, metal electrodes are evaporated down-facing surface of the on the core layer and silicon wafer, respectively, for poling, and then the core layer is poled by applying a predetermined power to both of the surfaces. After poling, the evaporated electrodes are removed by etching. Then, after forming the poled nonlinear polymeric core layer, a photo-resister layer is formed by the spin coating and, then, a waveguide structure is formed with lithography by using photo-mask of a waveguide structure patterned with a wavelength converter shape. Then, after etching remaining non-patterned region of the core layer by using reactive ion etching, the nonlinear polymeric core 160 is formed extending from the input end to the output end, by removing by etching the photo-resister, as shown. Then, the polymeric top cladding 140 is formed with the spin coating such that it covers the nonlinear polymeric core 160 substantially wholly. At this time, the exposed sides of the input end and the output end of an optical signal are not covered. These input end and output end are coupled to single mode fiber 110, 150, to which pump beam λₚ and signal beam λ1 are inputted, where the single mode fiber that is fixed at a V-groove is coupled to the input end and the output end of the wavelength converter by using polymeric bond.

During poling procedure of the nonlinear polymeric waveguide of the core layer, to efficiently produce DFG (Difference Frequency Generation), cascade process and second harmonic generation, i.e., to induce BPM (Birefringence Phase Matching), the nonlinear polymeric core 160 is electrically poled by applying voltage in the direction perpendicular to beam propagation to the metal electrodes, so as to align its nonlinear chromophere in the direction perpendicular to beam propagation. Otherwise, phase matching condition can be satisfied with, by separating a polymer waveguide, that is produced without poling process, from the silicon wafer, and stretching it with mechanical power to the direction of the waveguide.

Here, the BPM according to the present invention is a phase matching method for matching the phase velocities of optical waves interacting in wavelength conversion, which uses an effective refractive index changes of TE (Transverse Electric) and TM (Transverse Magnetic) propagation modes of an optical signal that is generated when the nonlinear polymer of the wavegiude structure are electrically poled or mechanically stretched.

For the wavelength converter comprising the prescribed polymer waveguide, it will be described for various conditions for generating BPM to raise energy conversion efficiency.

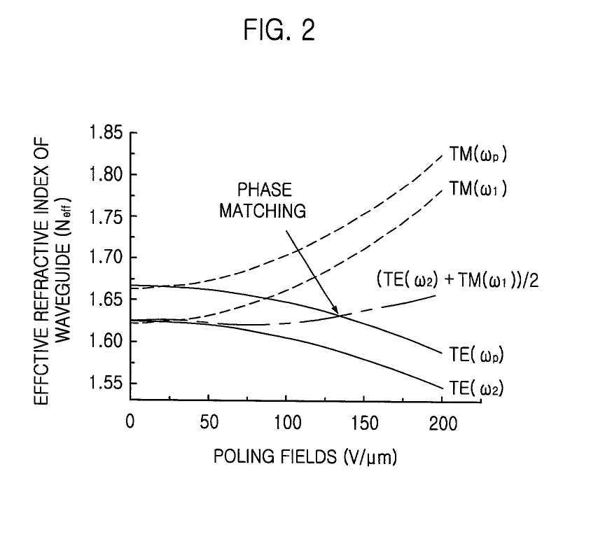

FIG. 2 is a graph for the effective refractive index change of propagation mode versus poling voltage of the nonlinear polymer.

TM(ω_{P}) and TM(ω₁) on the graph denote refractive indexes of TM polarization beam propagation mode for, respectively, a pump beam and a signal beam, and TE(ω_{P}) and TE(ω₂) denote refractive indexes of TE polarization beam propagation mode for, respectively, a pump beam and an output beam. In case that a voltage is applied to the nonlinear polymer of multiple layers, as shown in FIG. 1, to pole as shown above, as the poling voltage becomes higher, the effective refractive indexes of TM polarization beam propagation mode of the pump beam and the signal beam increase, while the effective refractive indexes of TE polarization beam propagation mode of the pump beam and the output beam are reduced. From this, when the pump beam and the signal beam are inputted to the wavelength converting device, the poling voltage (approximately 120 V/μm to 130 V/μm) at a point depicted by an arrow should be applied in order to generate efficiently DFG and cascade processes.

Now, it will be described for polarization states of the incident beam and the output beam that can be efficiently generate the difference frequency generation, the cascade process and the second harmonic generation by inducing the BPM of the present invention when the poling voltage under the prescribed condition is applied.

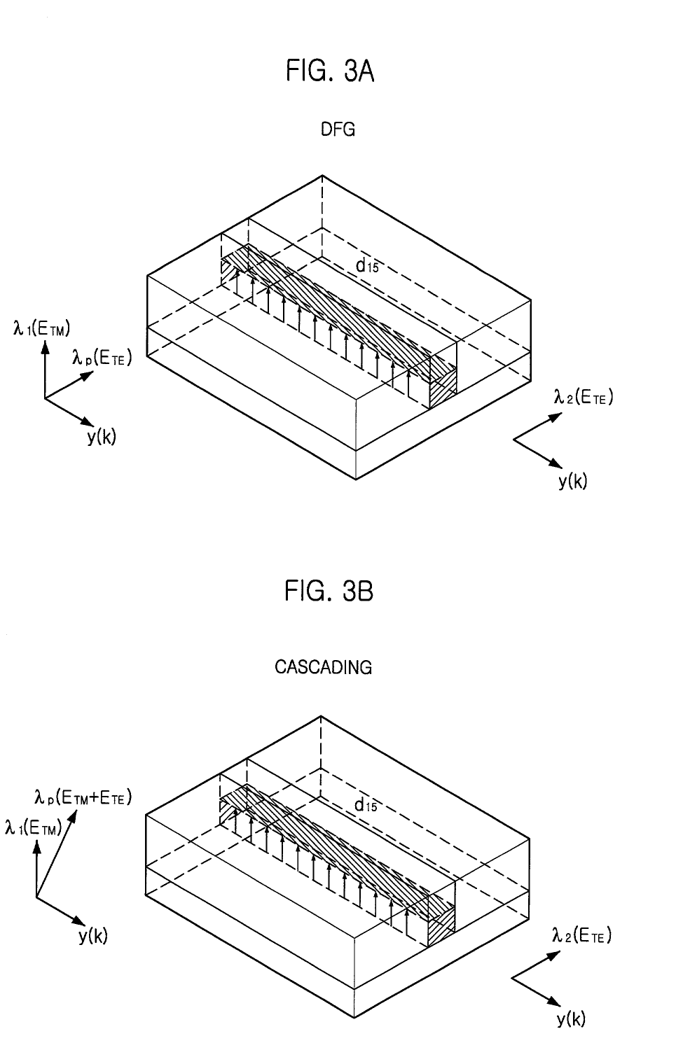

FIGS. 3A and 3B illustrate the polarization states of the incident beam and the output beam, where phase matching is satisfied with in the DFG and cascade process using the nonlinear polymer. In the DFG process, the polarization states of the incident beam and the output beam satisfying the BPM are as follows. For the incident beam that propagates along the direction of length of the waveguide, the TM polarized signal beam λ₁ and the TE polarized pump beam λₚ are inputted so that the TE polarized output beam λ₂ is outputted resulting in birefringence phase matching, as shown in FIG. 2.

Also, in the cascade process, the polarization states of the incident beam and the output beam satisfying the BPM are as follows. When compared with the DFG, the pump beam, where the TE polarization mode and the TM polarization mode are combined at 45 degrees angle, and the TM polarized signal beam are inputted to result in birefringence phase matching.

At this time, nonlinear material coefficient for satisfying the birefringence phase matching is d₁₅ and the poling voltage in the polymeric waveguide region is in poled state, where the poling voltage satisfying the BPM condition according to FIG. 2 is applied.

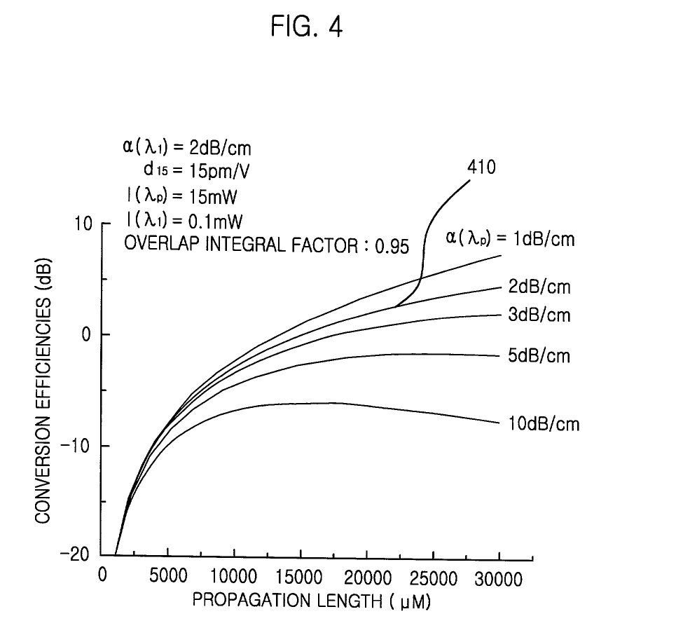

FIG. 4 illustrates a graph for energy conversion efficiency versus propagation distance of the waveguide, which is calculated when wavelength is converted by the DFG at BPM phase matching.

α(λ₁), d_{15l , I(λ}_{P}) and I(λ₁) on the graph denote an absorption for a signal beam, a non-linear coefficient of core material, an input of a pump beam and an input of a signal beam, respectively. Also, an overlap integral factor is set to 0.95. Variables used in calculation are practical values for real devices. As shown in FIG. 4, for a DFG device of which absorption 410 for the pump beam is 2 dB/cm and wavelength converting region is 3 cm long, if power of 15 mW pump beam and 0.1 mW signal beam is inputted, a device of 0 or more dB energy conversion efficiency can be manufactured. Based on propagation length of the converting region and the power of the pump beam and the signal beam, the energy conversion efficiency of the wavelength converter can be varied.

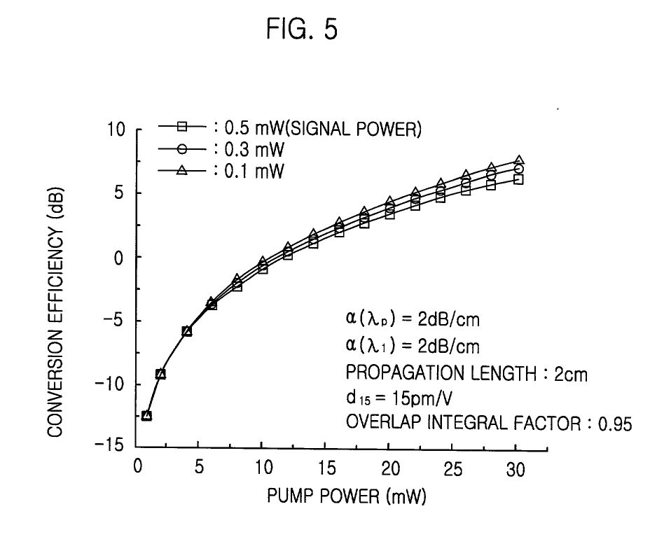

FIG. 5 presents a graph of energy conversion efficiency versus input power of the pump beam when the propagation length of the wavelength converting region is fixed as 2 cm.

α(λ_{P}), α(λ₁) and d₁₅ on the graph denote an absorption for a pump beam, an absorption for a signal beam and a non-linear material coefficient, respectively. Also, an overlap integral factor is set to 0.95. As shown in FIG. 5, when the energy of the inputted pump beam is equal to or more than 15 mW, values for the energy conversion efficiency are all equal to or greater than 0 dB for 0.1 mW, 0.3 mW and 0.5 mW signal beam energy values.

Now, it will be described for a DFG device and a cascade wavelength converting device, that are of high energy conversion efficiency, which use the BPM method in accordance with the present invention.

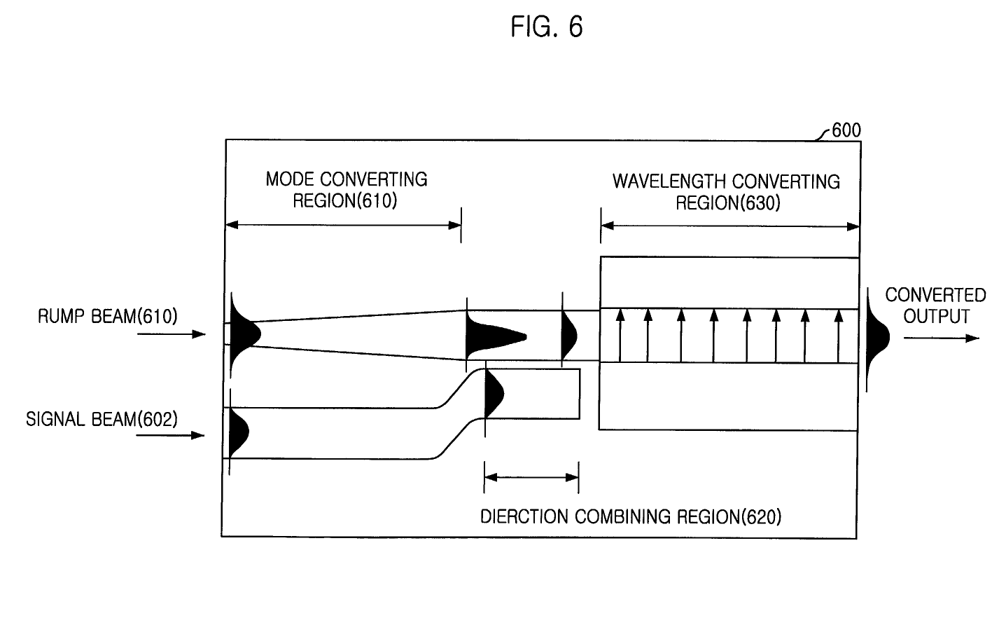

FIG. 6 show a DFG wavelength converter of waveguide structure using nonlinear polymer, which comprises a mode converting region 610 for converting the mode of the inputted pump beam, a direction combining region 620 for combining the inputted signal beam to the pump beam, and a wavelength converting region 630 for converting the wavelength of the signal beam combined to the pump beam. The mode converting region 610 and the wavelength converting region 620 are made of the nonlinear polymer material as integrated to form a line along the propagation direction. The side surface of the mode converting region 610 is exposed at the input side and the side surface of the wavelength converting region 630 is exposed at the output side.

Further, the mode converting region 610 is formed so that the area of the channel shape from the exposed side to the boundary with the wavelength converting region 630 varies gradually. In other words, since the wavelength of the pump beam 601 inputted through fiber is half times the wavelength of the signal beam 602, width of a tapered beam waveguide 611 is widened gradually along the propagation direction in order to properly superpose signal strength distribution of the signal beam 602 and the pump beam 601 within the waveguide.

In the DFG wavelength converter 600 having the prescribed characteristics, after the inputted pump beam 601 is converted to a single propagation mode during passage through the mode converting region 610, the signal beam of the single propagation mode is combined to the pump beam 601 during passage through the direction combining region 620. Then, the wavelength of the signal beam 602 is combined to the pump beam 601 during passage through the wavelength converting region 630 and, at this time, the polymer of the wavelength converting region 630 where wavelength conversion is occurred is in poled state, to which a predetermined voltage is applied to satisfy the BPM condition.

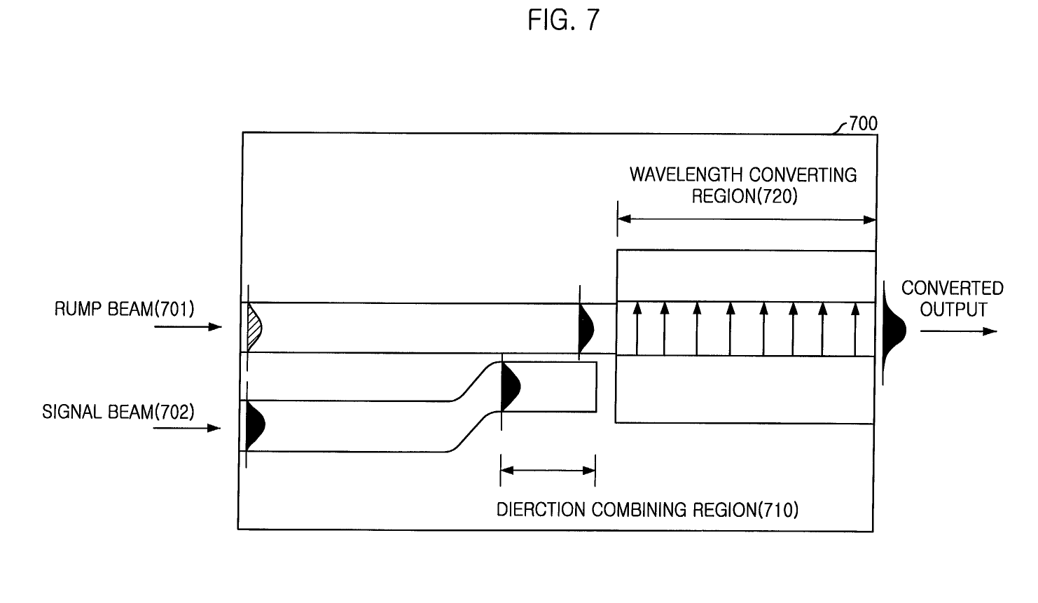

In the cascade wavelength converter 700 as shown in FIG. 7, since the wavelengths of the pump beam and the signal beam inputted through the fiber are similar to each other, the area from the exposed end to the boundary with the wavelength converting region 720 is formed as fixed, compared with the mode converting region 610 of the DFG wavelength converter 600 as shown in FIG. 6. Therefore, the mode of the pump beam 701 does not changed.

In the cascade wavelength converter 700 having the prescribed characteristics, the signal beam 702 is combined to the pump beam 701 during passage through a direction combiner of the waveguide structure and, then, the wavelength of the signal beam combined to the pump beam is converted during passage through the wavelength converting region 720. At this time, the polymeric waveguide of the wavelength converting region 720 is in poled state along the direction perpendicular to the propagation.

As described above, by using effective refractive indexes of TE and TM propagation modes of the beam signal generated by poling or stretching mechanically nonlinear polymer of waveguide structure, DFG wavelength converter, cascade wavelength converter and second harmonic generation device having high speed operation characteristic and higher energy conversion efficiency can be manufactured.

While the present invention has been shown and described with respect to the particular embodiments, it will be apparent to those skilled in the art that many changes and modifications may be made without departing from the spirit and scope of the invention as defined in the appended claims.

What is claimed is:

1. A method for converting wavelength of a signal beam combined to a pump beam, the method comprising of the steps of:
providing a channel type polymeric waveguide including nonlinear polymer in the middle of the waveguide;
poling the polymer along a predetermined direction by applying a voltage to the polymeric wavegiude; and
making the signal beam combined to the pump beam pass through the polymer waveguide in which the polymer is in poled state.

2. The method as recited in claim 1, further comprising the steps of:
making the pump beam pass through a polymeric mode converter before the signal beam is combined to the pump beam; and
combining the signal beam and the pump beam at a direction combining means after the pump beam passes through the polymeric mode converter.

3. The method as recited in claim 1, wherein, during the polymer poling step, the voltage is applied in a direction perpendicular to the direction in which the signal beam pass through the polymer waveguide.

4. A wavelength converter for converting wavelength of a signal beam combined to a pump beam, comprising:
a mode converting region for converting mode of the pump beam;
a direction combining region for combining the signal beam to the pump beam; and
a wavelength converting region for converting the wavelength of the signal beam combined to the pump beam,
wherein the mode converting region and the wavelength converting region are formed as integrated by nonlinear polymeric material to construct a polymeric waveguide extended along propagation direction, and the wavelength converting region is manufactured by including voltage applying means for applying a voltage to pole the polymer to a predetermined direction.

5. The wavelength converter as recited in claim 4, wherein the polymeric waveguide is formed to show a channel type shape having a rectangular cross-section,
the polymeric waveguide is wrapped by a cladding from the mode converting region to the wavelength converting region,
the side surface of the mode converting region is exposed at an input side and the side surface of the wavelength converting region is exposed at an output side.

6. The wavelength converter as recited in claim 5, wherein the mode converting region is formed such that the area of the channel type shape from the exposed side to the boundary with the wavelength converting region vary gradually.

7. The wavelength converter as recited in claim 5, wherein the mode converting region is formed such that the area of the channel type shape from the exposed side to the boundary with the wavelength converting region is fixed and the mode of the pump beam does not vary.

8. The wavelength converter as recited in claim 4, wherein the voltage applying means of the nonlinear polymer includes metal electrodes that is vacuum-evaporated to the nonlinear polymeric wavelength.

9. A method for manufacturing a wavelength converter for converting wavelength of a signal beam combined to a pump beam, by using nonlinear polymeric material, the method comprising the steps of:
shaping the nonlinear polymeric material to be long;
by using the shaped long nonlinear polymeric material as a core, wrapping the core with a cladding with leaving both ends exposed; and
forming metal electrodes connected to the core of the nonlinear polymeric material.

10. The method as recited in claim 9, wherein the step of wrapping includes the steps of:
providing a bottom cladding prior to the step of shaping; and
providing a top cladding after the step of shaping.

11. The method as recited in claim 9, wherein the step of forming the metal electrodes includes the step of vacuum-evaporating metal on down facing surfaces of the core of the nonlinear polymeric material and a silicon substrate.

12. The method as recited in claim 9, wherein, during the step of shaping, a mode converting region for converting mode of the pump beam, a direction combining region for combining the signal beam to the pump beam, and a wavelength converting region for converting the wavelength of the signal beam combined to the pump beam are formed simultaneously.

13. The method as recited in claim 12, wherein, during the step of shaping, the mode converting region and the wavelength converting region are formed as integrated such that they constructs a polymeric waveguide that forms a line along wave propagation direction.

14. The method as recited in claim 13, wherein, during the step of shaping, the polymer waveguide is formed as a channel type shape having rectangular cross-section.

15. The method as recited in claim 14, wherein, during the step of shaping, the area of the channel type shape from the exposed side surface of the mode converting region to the boundary with the wavelength converting region is formed to vary gradually.

16. The method as recited in claim 14, wherein, during the step of shaping, the area of the channel type shape from the exposed side surface of the mode converting region to the boundary with the wavelength converting region is formed to be fixed.
